(19) United States
(12) Patent Application Publication
(10) Pub. No.: US 2021/0274718 A1
(43) Pub. Date: Sep. 9, 2021

(54) COVERING SYSTEM FOR SILAGE PREPARATION

(71) Applicant: RKW Agri GmbH & Co. KG, Frankenthal (DE)

(72) Inventor: Estelle Cheret, Kalmthout (BE)

(73) Assignee: RKW Agri GmbH & Co. KG, Frankenthal (DE)

(21) Appl. No.: 16/336,631

(22) PCT Filed: Sep. 7, 2017
(86) PCT No.: PCT/EP2017/072482

§ 371 Date: Mar. 26, 2019

(30) Foreign Application Priority Data
Sep. 29, 2016 (DE) 102016118551.5

(51) Int. Cl. A01F 25/13; B32B 27/08; B32B 27/20; B32B 27/34

(52) U.S. Cl. CPC A01F 25/13; B32B 27/08; B32B 27/20; B32B 27/34; B32B 2307/7246; B32B 2307/402; B32B 2307/71; B32B 2410/00; B32B 2307/7244; B32B 2250/24

(57) ABSTRACT

A covering system for silage preparation. The covering system (1) includes at least one underlay film (2), which rests on the surface of a feedstuff (6). The underlay film (2) has an oxygen barrier layer (3). At least 50 wt % of the oxygen barrier layer (3) is formed of one or more material/s from the group including polyamide, co-polyamide, polyester, co-polyester, polyethylene, ethylene vinyl alcohol, polyvinyl alcohol, or mixtures thereof. The underlay film (2) also has an inner protective layer (4) facing the silage.

### BACKGROUND

The invention relates to a covering system for silage preparation, which comprises at least one underlay film, which closely hugs the surface of a fodder material.

Silage is a fodder for farm animals, mainly ruminants, which is preserved by lactic acid fermentation. However, renewable raw materials which are used as an energy source in biogas plants are also rendered storable by silaging. Essentially all green fodder materials, inter alia grass (grass silage), maize (maize silage), clover or even cereals (as whole plant silage) can be silaged.

Three basic forms are distinguished for the creation and storage of silage: the nowadays seldom encountered tower silo, the bunker silo (open fermentation heap or clamp) and the bale or tube silo.

The most important in terms of quantity and most economical mode of silage preparation consists in covering green fodder which is dumped onto heaps on the ground, with films. Here once again a distinction is made from clamps which are secured onto the ground and bordered on the side walls by concrete walls and open fermentation heaps which have no structural side boundary walls. Such bunker silos, that is open fermentation heaps or clamps, are also described as heap silos.

Conventionally, stable films based on polyethylene are used for covering heap silos. However in the use of these conventional films, mold formation repeatedly occurred due to the penetration of oxygen.

In EP 1 035 762 B1, a plastic film is described which consists of an isolating air- and in particular oxygen-tight plastic material. The film comprises at least one layer of a polyamide.

EP 2 286 658 B1 describes a silo film which has at least one layer of a resin composition layer, which contains a saponified copolymer based on ethylene vinyl acetate with an ethylene content of 20-60 mol. % and a saponified copolymer based on ethylene vinyl acetate with an ethylene content of 70 to 98%.

According to recent prior art, several films are used for covering heap silos. Here, in practice for the silaging two films of different thicknesses are arranged one over the other. The lower film, which is arranged directly on the fodder material, is described as the underlay film. The thin underlay film as it were “clings” onto the freshly silaged fodder, hence this is film is also referred to as “clinging film”, “seal film” or “sealing film”. The more closely the film adapts itself to the fodder stack, the less oxygen remains after covering in the silo and the less oxygen can penetrate into the fodder stack during removal. Through the use of an underlay film which closely hugs the fodder, mold formation and the undesired growth of yeast fungi are prevented.

Covering systems are known in which a thicker silo film is positioned over this thin underlay film. The thicknesses of normally used underlay films here are about 40 μm, while normally used silo films have thicknesses in the range 120-200 μm. Silo films have the task of protecting the underlay film from UV light and mechanical stress.

In these normal systems with several films, the underlay film as a rule consists of a polyolefin film. The silo film is also normally a polyolefin film, which has however a greater thickness compared to the underlay film.

DE 10 2009 0252 948 B4 describes a covering system with an underlay film of a polyamide and a silo film of a polyethylene. The thin underlay film of the polyamide closely hugs the surface of the fodder heap and thus acts as an effective oxygen barrier, which effectively prevents mold formation.

In EP 3 009 263 A1, a stretch film for wrapping material is described. The stretch film comprises a barrier layer, which is positioned between two polyolefin layers. The film has low permeability for oxygen and water vapor.

The lactic acid forming during the fermentation can attack the underlay film. This can lead to damaging of the polymer and thus to a reduced lifetime or to leakages.

### SUMMARY

The purpose of the invention is to provide a covering system for silage preparation which effectively prevents both the mold formation and the growth of yeast fungi. In addition, the covering system should be characterized by good mechanical durability and should offer security against damage due to birds, hail and the like. In addition, as part of renewable development, the covering system should be characterized by good recyclability and high resource efficiency.

This object is achieved according to the invention in that the underlay film has an inner protective layer facing the silage, which protects the oxygen barrier layer from the effects of the substances forming in the silage, in particular the action of lactic acid.

Preferably, at least 50 wt. % of the protective layer of the underlay film consists of materials of the group comprising polyethylene, polypropylene, ethylene vinyl acetate (EVA), ethylene butyl acrylate (EBA), copolymers of ethylene and other vinyl monomers and copolymers of propylene and other vinyl monomers.

Through a skillful combination of an oxygen barrier layer which preferably consists of a polyamide with a protective layer which preferably consists of a polyethylene, a sufficiently flexible and nonetheless stable underlay film is created which clings onto the surface of the fodder heap and thus prevents the formation of cavities, at the same time acts as an oxygen barrier and in addition exhibits high resistance to lactic acid.

In a particularly advantageous modification of the invention, the thickness of the underlayer film is at most 60 μm, preferably 50 μm, in particular at most 40 μm. The thin implementation of the underlay film, which according to the invention comprises an extremely effective oxygen barrier layer, which is combined with a protective layer, ensures effective clinging of the underlay film and at the same time an efficient oxygen barrier, which is protected against the action of lactic acid.

In order to avoid damage to the underlay film, for example by mechanical influences, it has moreover been found especially favorable if the underlay film has a thickness of at least 10 μm, preferably at least 15 μm, in particular at least 20 μm.

In a particularly favorable modification of the invention, the oxygen barrier layer is thicker than the protective layer at least by the factor 1.2, preferably at least by the factor 1.4, in particular at least by the factor 1.6, with it being found particularly favorable if the oxygen barrier layer is thicker than the protective layer at least by the factor 1.8. Through this favorable ratio of the thickness of the oxygen barrier layer to the thickness of the protective layer, an underlay film is created which while it is flexible enough to closely hug the silage, at the same time has high impermeability towards oxygen and in addition is active against the effects of lactic acid of the silage. In one modification of the invention, the ratio of the thickness of the oxygen barrier layer to the thickness of the protective layer is 2:1. Thus for example an underlay film which has an oxygen barrier layer of polyamide with a thickness of 20 μm and a protective layer of polyethylene of 10 μm has been found advantageous.

The oxygen permeability of the multilayer underlay film according to DIN 53380-3 at 23° and 50% relative humidity is at most 500 cm³/m²·d·bar, preferably at most 300 cm³/m²·d·bar, in particular at most 200 cm³/m²·d·bar. In the context of the present invention, this water permeability is determined according to DIN 53380-3 at 23° and 50% relative humidity. In a particularly advantageous modification, the underlay film has an oxygen permeability of at most 100 cm³/m²·d·bar.

Preferably the combination according to the invention of the oxygen barrier layer with the protective layer in the underlay film is selected so skillfully that together with as low as possible an oxygen permeability, at the same time as high as possible a water vapor permeability is imparted. The water vapor permeability of the underlay film according to ISO 15106-3 at 23° C. and 85% relative atmospheric humidity is at least 5 g/m²·d, preferably at least 10 g/m²·d, in particular at least 15 g/m²·d. Thereby it is achieved that the moisture can diffuse out from the fodder stack through the underlay film and thus a moisture equilibrium is established between fodder stack and underlay film. Through this diffusion of moisture through the underlay film, a thin moisture film can form between underlay film and a silo film, which contributes to a separation of the underlay film from the silo film. In contrast, with conventional underlay films diffusion of moisture through the underlay film is largely excluded, so that the moisture of the film collects on the underlay film and cannot pass through the underlay film. In contrast, with the film according to the invention, part of the moisture passes through the underlay film and collects as a film between the underlay film and the silo film, so that a separation of the two film is caused thereby and hence the underlay film can cling onto the surface of the fodder stock.

In a particularly advantageous embodiment of the invention, the covering system, as well as the underlay film according to the invention, comprises a silo film. The silo film is preferably markedly thicker than the underlay film and has the task of protecting the underlay film from mechanical stress and optionally also UV light.

In one modification of the invention, the underlay film according to the invention and the silo film form one unit for covering the fodder heap in one operation. This unit is preferably formed in that the underlay film and the silo film are rolled up together or folded together, so that combined joint unrolling or unfolding in one operation is possible. Through this combination of a silo film with an underlay film, an effective oxygen barrier is created which can be applied onto the silo in only one operation. The underlayer film adhering to the silo film then after use in a relatively short time detaches itself from the silo film and clings onto the silage, so that the silage is effectively sealed against penetration of oxygen. Hence the underlay film is also described as a sealing film. After laying out, with the incipient fermentation process the underlay film takes up moisture from the silo contents. In the process, its strength, puncture resistance and stretching increase significantly. The water vapor permeability of the underlay film forces the separation of the underlay film from the silo film from the silo film. The water vapor from the silage diffuses through the underlay film and condenses on the silo film, which blocks the water vapor. After a few days, the separation of the film combination is perfect. The underlay film closely hugs the surface of the silage. Thus moisture pockets and the mold risk associated therewith are effectively avoided.

The unit according to the invention of an underlay film with a silo film is combined here such that after the application of this unit in one working step, the underlay film separates from the silo film and then closely hugs the surface of the heap.

In one modification of the invention, within the underlay film the protective layer is present separate from the oxygen barrier layer. Here the underlay film can already consist of two separated layers from the outset or the separation of the protective layer from the oxygen barrier layer takes place only after the application of the covering system. In this case, the protective layer then separates independently from the oxygen barrier layer only after the application of the covering system. In one modification of the invention, the protective layer clings onto the silage. By the oxygen barrier layer, the silage is effectively sealed against penetration of oxygen.

Preferably, the silo film of the covering system has a lower water vapor permeability than the underlay film. Here it is found favorable if the water vapor permeability of the silo film according to ISO 15106-3 at 23° C. and 85% relative atmospheric humidity is at most 3.0 g/m²·d, preferably 2.5 g/m²·d, in particular 2.0 g/m²·d. As a result, the water vapor which diffuses out of the silage through the underlay film can collect on the silo film, which according to the invention blocks the water vapor. As a result, the separation of the underlay film from the silo film is improved, so that the silo film can perfectly cling onto the fodder stack and thus forms an adherent sealing film.

Preferably, the underlay film in the oxygen barrier layer, apart from materials from the group comprising polyamide, copolyamide, polyester, copolyester, polyethylene vinyl alcohol, polyvinyl alcohol and mixtures thereof contains at most 20 wt. % of polymeric constituents, preferably no further polymeric constituents.

In a particularly advantageous modification, the oxygen barrier layer of the underlay film consists of polyamides and copolyamides, preferably mixtures of PA 6, PA 6/66, PA66, PA 616T and/or other aliphatic, aromatic or partly aromatic polyamides or copolyamides. Preferably, the oxygen barrier layer contains at least 50%, preferably at least 70% and still more preferably at least 90% of one or more materials from the group comprising polyamide and copolyamide, preferably PA6, PA66, PA 6/66, PA 616T and/or other aliphatic, aromatic or partly aromatic polyamides or copolyamides.

According to the invention, the underlay film consists at least of one oxygen barrier layer and one protective layer. The underlay film can have additives in one, several or all layers, for example to increase the stability against UV radiation and/or lubricants and/or mineral antiblock additives to reduce the coefficients of friction of the film surface and/or additives for coloring.

It has been found advantageous to lay the covering system with a higher water content in the underlay film than is contained after the extrusion of the film. A moisture content of 2 wt. % or more is preferred, based on the materials from the group comprising polyamide, copolyamide, polyester, copolyester, EVOH and PVOH contained in the underlay film. The water content can for example be introduced during production via spray nozzles or a water bath.

The silo film preferably contains low density polyethylene (LDPE), medium density polyethylene (MDPE), high density polyethylene (HDPE), copolymers of ethylene and α-olefins (LLDPE), copolymers of ethylene and vinyl acetate (EVA), copolymers of ethylene and ethylenically unsaturated acids or esters, in particular acrylic acid, methacrylic acid and esters thereof (ethyl methyl acrylate EMA), ethylene ethyl acrylate (EEA), ethylene butyl acrylate (EBA), polypropylene (PPO), heterophasic (block-co-PP) or homogeneous (random-co-PP) copolymers of polyethylene and ethylene. It is advantageous if no further polymeric constituents are contained other than materials from the group comprising polyethylene, polypropylene, copolymers of ethylene and other vinyl monomers, and copolymers of propylene and other vinyl monomers. Vinyl monomers should be understood to mean those with an ethylene group, which are copolymerizable with ethylene. These include above all, but not exclusively, α-olefins with two to 12 carbon atoms—for example ethylene, propylene, butene, pentene, hexene and octene—, acrylic acid and esters thereof, methacrylic acid and esters thereof, styrene, dienes—for example butadiene and isoprene—, vinyl acetate, cycloolefins—for example norbornene and cyclopentadiene—and carbon monoxide.

The silo film can contain mineral fillers such as for example, but not exclusively, calcium carbonate or talc to increase the stiffness. The silo film can contain additives in normal quantities, for example UV stabilizers and/or lubricants and/or mineral antiblock additives for decreasing the coefficients of friction of the film surface and/or additives for coloring the film.

The silo film preferably has a thickness between 50 μm and 200 μm, particularly preferably between 50 μm and 150 μm and especially preferably between 60 and 120 μm.

It has been found particularly favorable if the underlay film and the silo film in the covering system according to the invention are produced together by coextrusion. In this, it is found particularly advantageous if the underlay film and the silo film are produced in the coextrusion with a low interlayer adhesion, for the separation of the underlay film from the silo film. Through this coextrusion with low interlayer adhesion, a covering system is created in which the underlay film can separate from the silo film after the application in one operation. The covering system is thus a prefinished unit, wherein with this prefinished unit the underlay film is rolled up and/or folded together with the silo film and thus can be applied onto the heap silo in one operation by unrolling and/or unfolding together.

In one preferred embodiment, at least one layer of the covering system consists of an extruded single or multilayer plastic film with at least one layer which contains a foam structure. This is favorable especially for the separation of the underlay film from the silo film in the covering system produced by coextrusion with low interlayer adhesion.

The unrolled covering system preferably has a rectangular shape.

The width of the covering system is preferably at least 3 m, particularly preferably at least 4 m, in particular at least 5 m and/or at most 21 m, particularly preferably at most 20 m, in particular at most 19 m.

The length of the covering system is preferably at least 20 m, particularly preferably at least 30 m, in particular at least 40 m.

### BRIEF DESCRIPTION OF THE FIGURES

Below, the invention is illustrated on the basis of examples, without however being limited to the specifically described embodiments. Unless otherwise stated, the percentage data relate to the weight, in case of doubt to the total weight of the mixture. The invention also relates to all combinations of the expedient, favorable and preferred configurations insofar as these are not mutually exclusive. The statements “about” or “circa” in connection with a numerical value mean that at least values 10% higher or lower, or values 5% higher or lower, and in any case values 1% higher or lower are included.

Here the following figures show:

FIG. 1 a schematic cross-section diagram through the covering system according to the invention,

FIG. 2 the covering system directly after application onto the fodder stack, and

FIG. 3 the detachment of the underlay film from the silo film.

### DETAILED DESCRIPTION

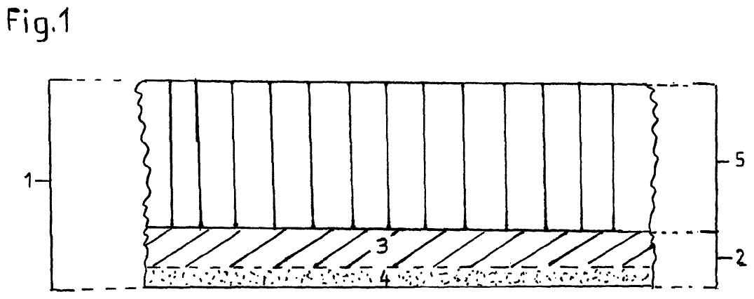

FIG. 1 shows a covering system 1 for silage preparation. The covering system 1 comprises an underlay film 2. The underlay film has an oxygen barrier layer 3 and a protective layer 4.

In the practical example, the thickness of the underlay film 2 is ca. 30 μm, wherein the oxygen barrier layer 3 has a thickness of 20 μm and the protective layer 4 a thickness of 10 μm. The oxygen barrier layer 3 is thus thicker than the protective layer 4 by the factor of 2.

The thin underlay film 2 clings by adhesion onto the freshly silaged fodder. Through this close hugging the formation of cavities is prevented.

In addition, for the separation of the underlay film 2 from the silo film 5, there can also be a separation of the oxygen barrier layer 3 and protective layer 4 within the underlay film 2. This modification is not shown in the figures.

In the practical example, at least 80% of the oxygen barrier layer 3 consists of PA 6/66.

According to the invention, in the underlay film 2 the oxygen barrier layer 3 is combined with a protective layer 4. At least 50%, preferably at least 70%, in particular at least 90% of the protective layer 4 consists of materials from the group comprising polyethylene, polypropylene, ethylene vinyl acetate (EVA), ethylene butyl acrylate (EBA), copolymers of ethylene and other vinyl monomers and copolymers of propylene and other vinyl monomers. This polyolefin protective layer 4 protects the oxygen barrier layer 3 from the action due to lactic acid which arises during the fermentation of the silage. As a result an underlay film 2 is created which because of its low thickness of only 30 μm clings onto the surface of the fodder material and closely hugs it such that the surface of the material is sealed against penetration into the oxygen and at the same time the formation of liquid pockets is effectively prevented, so that no mold formation occurs. At the same time, due to the thin coating of the oxygen barrier layer 3, which preferably consists of a polyamide with a protective layer 4, which preferably consists of a polyolefin, high durability and long lifetime of the underlay film 2 is ensured. Thereby, an oxygen-impermeable silage covering for the duration of the whole fermentation process is achieved.

In the practical example according to the drawing in FIG. 1, the oxygen barrier layer 4 consists of a polyethylene.

The covering system 1 according to the invention shown in FIG. 1 as well as the underlay film 2 comprises a silo film 5. For the preparation of the covering system 1, the silo film 5 is produced by coextrusion with the underlay film 2. According to the invention, underlay film 2 and silo film 5 form a combined unit for covering the fodder material heap in one operation.

In the practical example, the silo film 5 has a thickness of 80 μm. Thus, together with the underlay film 2, the thickness of the covering system is ca. 110 μm.

At least 70 wt. % of the silo film consists of a polyethylene.

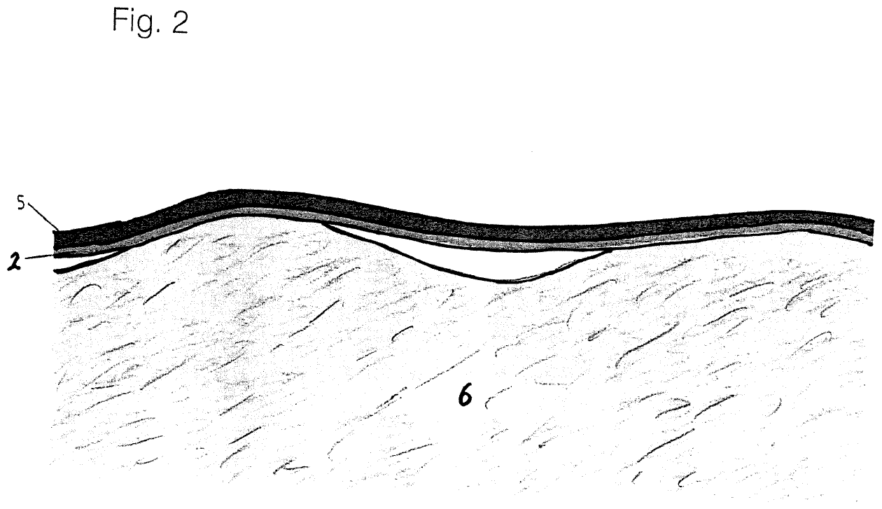

FIG. 2 shows the covering film 1 directly after it was applied onto a fodder material heap 6. The underlay film 2 adheres on the silo film 5.

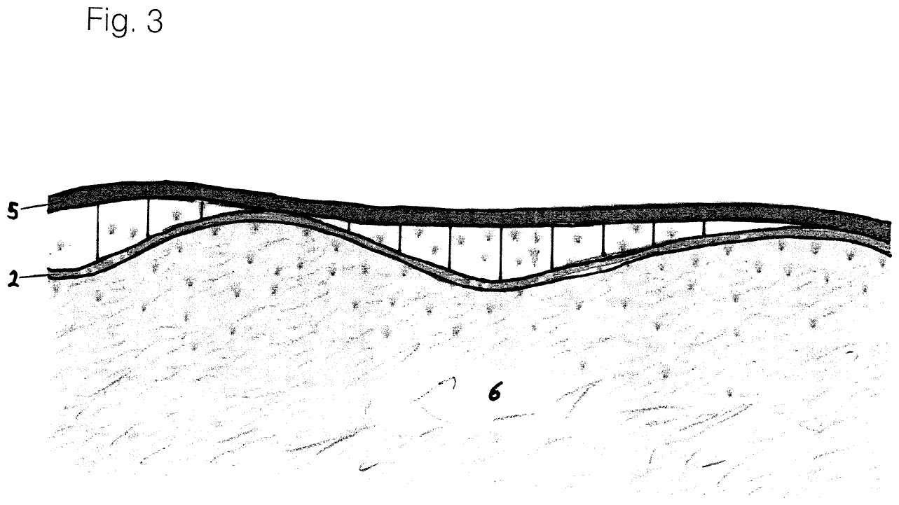

FIG. 3 then shows a situation in which the underlay film 2 has detached from the silo film 5 and has closely hugged the surface of the fodder material heap 6.

1. A covering system (1) for silage preparation comprising:
at least one underlay film (2) adapted to closely hug onto a surface of a fodder material (6), the underlay film (2) includes
at least one oxygen barrier layer (3), at least 50 wt. % whereof is formed of materials of the group consisting of polyamide, copolyamide, polyester, copolyester, polyethylene vinyl alcohol, polyvinyl alcohol, or mixtures thereof, and
at least one protective layer (4) that is adapted to protect the at least one oxygen barrier layer (3) against substances of the silage.

2. The covering system as claimed in claim 1, wherein at least 50 wt. % of the protective layer (4) is formed of materials from the group consisting of polyethylene, polypropylene, copolymers of ethylene with other vinyl monomers and copolymers of propylene with other vinyl monomers, ethylene vinyl acetate (EVA) or ethylene butyl acrylate (EBA).

3. The covering system as claimed in claim 1, wherein the underlay film (2) has a thickness of at most 50 μm.

4. The covering system as claimed in claim 1, wherein the oxygen barrier layer (3) is thicker than the protective layer (4) at least by the factor 1.4.

5. The covering system as claimed in claim 1, wherein the underlay film (2) has an oxygen permeability according to DIN 53380-3 at 23° and 50% relative humidity of at most 500 cm³/m²·d·bar.

6. The covering system as claimed in claim 1, wherein the underlay film (2) has a water vapor permeability according to ISO 15106-3 at 23° C. and 85% relative humidity of at least 5 g/m²·d.

7. The covering system as claimed in claim 1, wherein the at least one oxygen barrier layer (3) of the underlay film (2) further includes at most 20 wt. % of further polymeric constituents.

8. The covering system as claimed in claim 1, wherein the at least one oxygen barrier layer (3) of the underlay film (2) is formed form at least one of polyamide or copolyamide.

9. The covering system as claimed in claim 1, wherein the underlay film (2) in at least one of the at least one oxygen barrier layer or the at least one protective layer (3, 4) contains at least one of additives for increasing a stability against UV radiation, lubricants, mineral antiblock additives for reducing coefficients of friction of the film surface, or coloring additives.

10. The covering system as claimed in claim 1, further comprising a silo film (5) which with the underlay film (2) forms a unit for covering in one operation, wherein the unit is formed in that the underlay film (2) and the silo film (5) are at least one of rolled up or folded together for combined unrolling, unfolding, or both in one operation.

11. The covering system as claimed in claim 10, wherein the underlay film (2) is separable from the silo film (5) for closely hugging the surface of the fodder material heap (6).

12. The covering system as claimed in claim 10, wherein the silo film (5) has a lower water permeability than the underlay film (2).

13. The covering system as claimed in claim 10, wherein the silo film (5) has a water vapor permeability according to ISO 15106-3 of at most 3 g/m²·d.

14. The covering system as claimed in claim 10, wherein at least 70 wt. % of the silo film (5) is formed of one or more materials from the group consisting of:
low density polyethylene (LDPE),
medium density polyethylene (MDPE),
high density polyethylene (HDPE),
copolymers of ethylene and α-olefins (LLDPE),
copolymers of ethylene and vinyl acetate (EVA),
copolymers of ethylene and acrylic acid, methacrylic acid or esters thereof,
ethylene butyl acrylate (EBA),
polypropylene (PP), or
heterophasic (block co-PP) or homogeneous (random CE-PP) copolymers of propylene and ethylene.

15. The covering system as claimed in claim 10, wherein the underlay film (2) and the silo film (5) are produced together by coextrusion with low interlayer adhesion for separation of the underlay film (2) from the silo film (5).

16. The covering system as claimed in claim 10, wherein at least one of the silo film or the underlay film has in at least one layer a foam structure for the separation of the silo film (5) from the underlay film (2).

17. The covering system as claimed in claim 10, wherein the silo film (5) has a thickness of at least 50 μm.

18. The covering system as claimed in claim 1, wherein the protective layer (4) is separated from the oxygen barrier layer (3).

19. A roll with a covering system as claimed in claim 1.

20. A method for silage preparation comprising the following steps:
applying a covering system (1) as claimed in claim 10 in which the underlay film (2) together with the silo film (5) is applied in one operation onto a fodder material heap (6),
the underlay film (2) detaching from the silo film (5) through soaking of moisture from the heap (6) and the underlay film hugging a surface of the fodder material heap (6).

21. (canceled)
